(19) United States
(12) Patent Application Publication
(10) Pub. No.: US 2025/0103480 A1
(43) Pub. Date: Mar. 27, 2025

(54) DATA MANAGEMENT METHOD AND DATA MANAGEMENT DEVICE

(71) Applicant: Sercomm Corporation, Taipei (TW)

(72) Inventor: Xinyue Fei, Jiangsu (CN)

(73) Assignee: Sercomm Corporation, Taipei (TW)

(21) Appl. No.: 18/796,230

(22) Filed: Aug. 6, 2024

(30) Foreign Application Priority Data
Sep. 22, 2023 (CN) 202311235114.X

(51) Int. Cl. G06F 12/02

(52) U.S. Cl. CPC G06F 12/023

(57) ABSTRACT

A data management method and device are provided. The method includes: in response to a first data type of first data to be written into a memory medium, obtaining a space size of a first write space of the first data; in response to determining that the space size is not less than or equal to a total free space of the memory medium, determining whether there is an excess data type among the data types; in response to determining that there is the excess data type, deleting at least part of second data belonging to the excess data type, updating the total free space, and determining whether the space size is less than or equal to the updated total free space; and in response to determining that the space size is less than or equal to the updated total free space, writing the first data into the memory medium.

### CROSS-REFERENCE TO RELATED APPLICATION

This application claims the priority benefit of China application serial no. 202311235114.X, filed on Sep. 22, 2023. The entirety of the above-mentioned patent application is hereby incorporated by reference herein and made a part of this specification.

### BACKGROUND

### Technical Field

The disclosure relates to a data management mechanism, and more particularly to a data management method and a data management device.

### Description of Related Art

Cameras or other embedded apparatuses usually need to continuously operate such as recording video, taking snapshots of events, and recording operation logs, and continuously record various types of data on memory media. The memory media may be secure digital (SD) cards, embedded multimedia cards (eMMC), flash memories, cloud disks, etc.

Since the total memory space of the memory medium is limited, a reasonable memory space is usually allocated for each type of data in advance in the memory medium. If data memory of the same type is full, the approach of overwriting oldest data of the same type with latest data of the same type is usually adopted.

In this way, although the approach ensures that there is space for storing each type of data, but the approach also leads to the following disadvantages. (1) The upper limit of the memory space of a single type is always limited to a specified size. (2) If some types of data do not fully occupy the allocated memory spaces, the unoccupied memory spaces cannot be used for other purposes, and the total space of the memory medium can never be fully utilized. (3) Some types of data may not have been updated for a long time, but still occupy a large amount of space. (4) Once the space allocation of a certain type is reduced, older data that exceeds the allocated space is deleted, so there is a risk of data loss due to misoperation. Also, at this time, there is suddenly an extra free space, so the memory medium is not fully utilized.

### SUMMARY

Embodiments of the disclosure provide a data management method and a data management device, which may be used to solve the above technical issues.

An embodiment of the disclosure provides a data management method, which is adapted to a data management device and includes the following steps. In response to a first data type of first data to be written into a memory medium, a space size of a first write space of the first data is obtained. The memory medium is configured with multiple memory spaces, the memory spaces respectively correspond to multiple data types, the data types include the first data type, and the first data type corresponds to a first memory space among the memory spaces. Whether the space size of the first write space of the first data is less than or equal to a total free space of the memory medium is determined. In response to determining that the space size of the first write space of the first data is not less than or equal to the total free space of the memory medium, whether there is an excess data type among the data types is determined. A space size occupied by at least one second data belonging to the excess data type in the memory medium is greater than a pre-allocated memory space corresponding to the excess data type among the memory spaces. In response to determining that there is the excess data type, a part of the at least one second data belonging to the excess data type is deleted, the total free space of the memory medium is updated, and whether the space size of the first write space of the first data is less than or equal to the updated total free space is determined. In response to determining that the space size of the first write space of the first data is less than or equal to the updated total free space, the first data is written into the memory medium.

An embodiment of the disclosure provides a data management device, which is used to manage a memory medium and includes a memory circuit and a processor. The memory circuit stores a program code. The processor is coupled to the memory circuit and accesses the program code to execute the following operations. In response to a first data type of first data to be written into the memory medium, a space size of a first write space of the first data is obtained. The memory medium is configured with multiple memory spaces, the memory spaces respectively correspond to multiple data types, the data types include the first data type, and the first data type corresponds to a first memory space among the memory spaces. Whether the space size of the first write space of the first data is less than or equal to a total free space of the memory medium is determined. In response to determining that the space size of the first write space of the first data is not less than or equal to the total free space of the memory medium, whether there is an excess data type among the data types is determined. A space size occupied by at least one second data belonging to the excess data type in the memory medium is greater than a pre-allocated memory space corresponding to the excess data type among the memory spaces. In response to determining that there is the excess data type, a part of the at least one second data belonging to the excess data type is deleted, the total free space of the memory medium is updated, and whether the space size of the first write space of the first data is less than or equal to the updated total free space is determined. In response to determining that the space size of the first write space of the first data is less than or equal to the updated total free space, the first data is written into the memory medium.

Based on the above, the technical solutions of the embodiment of the disclosure can utilize the memory medium more efficiently.

### BRIEF DESCRIPTION OF THE DRAWINGS

The drawings are included to provide a further understanding of the disclosure, and the drawings are incorporated into the specification and constitute a part of the specification. The drawings illustrate embodiments of the disclosure and serve to explain principles of the disclosure together with the description.

FIG. 1 is a schematic diagram of a data management device, a memory medium, and a data source device according to an embodiment of the disclosure.

FIG. 2 is a flowchart of a data management method according to an embodiment of the disclosure.

FIG. 3 is a flowchart of another data management method according to FIG. 2.

FIG. 4 is a flowchart of yet another data management method according to FIG. 2.

### DESCRIPTION OF THE EMBODIMENTS

Reference will now be made in detail to the exemplary embodiments of the disclosure, and examples of the exemplary embodiments are illustrated in the drawings. Wherever possible, the same reference numerals are used in the drawings and the description to refer to the same or similar parts.

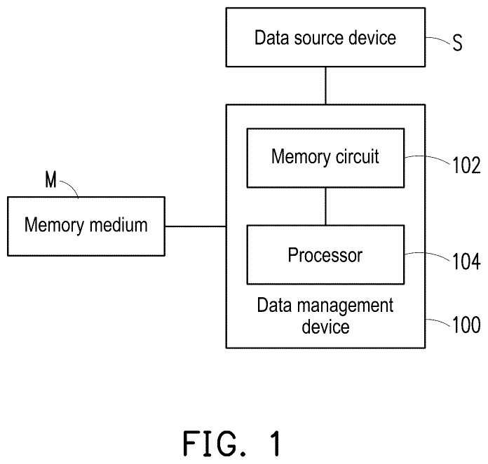

Please refer to FIG. 1, which is a schematic diagram of a data management device, a memory medium, and a data source device according to an embodiment of the disclosure. In different embodiments, a data management device 100 may be implemented as various electronic devices, smart devices, computer devices, and previously mentioned embedded apparatuses, various monitoring devices and access control systems, etc., such as an artificial intelligence (AI) access control system that supports facial recognition and liveness detection/body temperature detection and an enterprise intelligent monitoring integrated system.

In FIG. 1, the data management device 100 includes a memory circuit 102 and a processor 104 to manage a memory medium M. For example, the data management device 100 writes data into and reads data from the memory medium M according to data access requirements of a data source device S.

The data source device S may be a camera, a recorder, a temperature and humidity sensing device, or other sound, image, or environmental data sensing device and has data writing or reading requirements of one or more data types. In the embodiment of FIG. 1, only one data source device S is shown. In other embodiments, there may also be multiple data source devices, and the data source devices may respectively have data writing or reading requirements of one or more data types.

The memory circuit 102 is, for example, any type of fixed or removable random access memory (RAM), read-only memory (ROM), flash memory, hard disk, other similar devices, or a combination of the devices and may be used to record multiple program codes or modules.

The processor 104 is coupled to the memory circuit 102 and may be a general-purpose processor, a specific-purpose processor, a conventional processor, a digital signal processor, multiple microprocessors, one or more microprocessors in combination with a digital signal processor core, a controller, a microcontroller, an application specific integrated circuit (ASIC), a field programmable gate array (FPGA), any other type of integrated circuit, a state machine, a processor based on an advanced reduced instruction set computer (RISC) machine (ARM), and the like. In the embodiment, the memory circuit 102 and the processor 104 are respectively shown as two functional blocks for ease of description. In other embodiments, the memory circuit 102 and the processor 104 may also be implemented as a single device or different devices according to requirements.

The memory medium M may be a suitable type of fixed or removable random access memory, flash memory, hard disk, distributed array, cloud memory space, other similar devices, or a combination of the devices and may be used to store data. In the embodiment, the memory circuit 102 and the memory medium M are respectively shown as two functional blocks for ease of description. In other embodiments, the memory circuit 102 and the memory medium M may also be implemented as a single device or different devices according to requirements. For example, the memory circuit 102 may be a space in the memory medium M that may be used to write and read data.

According to different data types, data may be respectively allocated to memory spaces of the memory medium M. The memory medium M is configured with multiple memory spaces, and the memory spaces respectively correspond to multiple data types. The required data types may be defined according to different requirements. For example, data contents such as logs, videos, and audios may be set to different data types. In some embodiments, data corresponding to the same user/apparatus may also be set to the same data type, and data corresponding to different users/apparatuses may be set to different data types.

In an embodiment of the disclosure, different data types may be pre-allocated with corresponding memory spaces in the memory medium M. For example, assuming that there are N (where N is a positive integer) data types, then N memory spaces respectively corresponding to the N data types may be configured in the memory medium M.

In some embodiments, the sum of the memory spaces is less than the total size of the memory medium M. That is, a specific space that does not correspond to any data type may be configured in the memory medium M. In an embodiment, the specific space that does not correspond to any data type may be shared by multiple data types, that is, the specific space may be used to store data belonging to any data type sharing the specific space.

In an embodiment, the memory space corresponding to each data type may be by default or set by the processor 104. In some embodiments, the memory space corresponding to each data type may also be adjusted (such as being increased/decreased) by the user according to requirements.

In an embodiment of the disclosure, the processor 104 may access the modules and the program codes recorded in the memory circuit 102 to implement a data management method provided by the disclosure, and the details of which are described as follows.

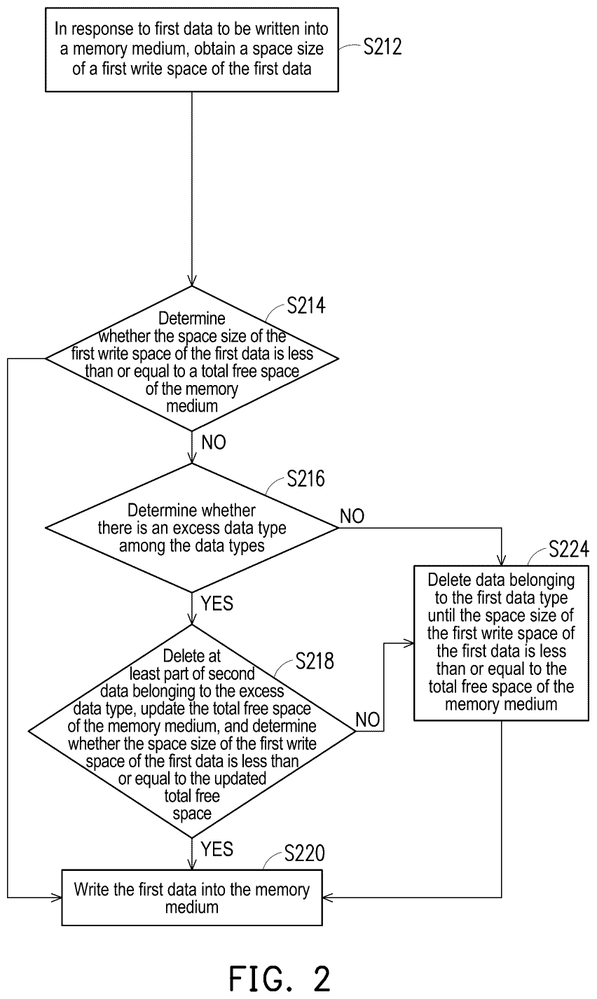

Please refer to FIG. 2, which is a flowchart of a data management method according to an embodiment of the disclosure. The method of the embodiment may be executed by the data management device 100 of FIG. 1. The following describes the details of each step of FIG. 2 with reference to the components shown in FIG. 1.

In step S212, in response to first data to be written into the memory medium M, the processor 104 obtains a first data type of the first data, and applies for a space size of a first write space of the first data.

In an embodiment, the first data is data that the data source device S requests the processor 104 to write into the memory medium M. In an embodiment of the disclosure, the first data type of the first data is one of the data types, and the first data type may correspond to a first memory space among the memory spaces. In addition, the first write space is a space required to write the first data into the memory medium M. For example, if the size of the first data is K (where K is a positive integer) bits, then the first write space is a certain number of bits not less than K bits.

In step S214, in response to the first data type of the first data to be written into the memory medium M, the processor 104 determines whether the space size of the first write space of the first data is less than or equal to a total free space of the memory medium M. In an embodiment, the memory medium M may have free spaces not storing any data according to the current memory state, and the sum/union of the free spaces may be the total free space of the memory medium M, but not limited thereto.

In an embodiment, in response to the processor 104 determining that the space size of the first write space of the first data is less than or equal to the total free space of the memory medium M, it means that the total free space of the memory medium M is sufficient for writing the first data. In this case, the processor 104 may correspondingly execute step S220 to write the first data into the memory medium M.

On the other hand, in response to the processor 104 determining that the space size of the first write space of the first data is not less than the total free space of the memory medium M, it means that the total free space of the memory medium M is insufficient for writing the first data. In this case, the processor 104 may correspondingly execute step S216 to determine whether there is an excess data type among the data types.

In the embodiment of the disclosure, data belonging to the excess data type refers to data of which the space size occupied in the memory medium M is greater than the pre-allocated memory space corresponding to the data type of the data.

Furthermore, in an embodiment of the disclosure, even if different data types are pre-allocated with corresponding memory spaces, when data of a certain data type (hereinafter referred to as A) occupies a pre-allocated memory space, the data belonging to the data type A may still be stored in other spaces in the memory medium M that are not yet storing any data.

For example, it is assumed that the data type A is allocated with a memory space with a size of 100 MB, and 90 MB of the memory space is already used to store the data belonging to the data type A. In this case, if the processor 104 intends to write another data of the data type A and with a size of 15 MB into the memory medium M, the processor 104 may write 10 MB of the other data into the memory space corresponding to the data type A to completely occupy the pre-allocated memory space, and write the remaining 5 MB of the other data into another space in the memory medium M without data stored. In different embodiments, the other space is, for example, a part of a memory space corresponding to another data type or the specific space shared by the data types, but not limited thereto.

In this case, the data type A is the excess data type in the embodiment of the disclosure. That is, the space size occupied by the data belonging to the data type A in the memory medium M is greater than the pre-allocated memory space corresponding to the data type A. In an embodiment of the disclosure, a difference value between the space size occupied by the data of the data type A in the memory medium M and the pre-allocated memory space corresponding to the data type A may be referred to as an excess usage portion of the data type A, but not limited thereto.

Based on this, in step S216, whether there is the excess data type among the data types is determined. If yes, the processor 104 executes subsequent operations.

In an embodiment, when there are multiple excess data types among the data types, the processor 104 may select any one of the excess data types to execute the subsequent operations.

In another embodiment, when there are multiple excess data types among the data types, the processor 104 may also select one of the excess data types according to a specific principle to execute the subsequent operations. For example, the processor 104 may select one of the excess data types having the highest excess usage portion to execute the subsequent operations. Alternatively, the processor 104 may also execute the subsequent operations on each excess data type.

In an embodiment, in response to the processor 104 determining in step S216 that there is the excess data type, the processor 104 may correspondingly execute step S218, otherwise, the processor 104 may execute step S224.

In step S218, the processor 104 deletes at least part of second data belonging to the excess data type, updates the total free space of the memory medium M, and determines whether the space size of the first write space of the first data is less than or equal to the updated total free space.

In the embodiment of the disclosure, after the processor 104 deletes the part of the second data belonging to the excess data type, the total free space of the memory medium M may be correspondingly increased. In other words, the updated total free space should be greater than the total free space before the update.

In different embodiments, the deleted part of the second data belonging to the excess data type includes at least one of the oldest data, the least important data, and unlocked data in the second data, but not limited thereto. That is, when the processor 104 determines that there is the excess data type, a part of the oldest, least important, and/or unlocked data may be deleted from the corresponding data to try to increase the total free space in the memory medium M, but not limited thereto.

In an embodiment, in response to the processor 104 determining in step S218 that the space size of the first write space of the first data is less than or equal to the updated total free space, it means that the total free space in the memory medium M is sufficient to accommodate the first data. In this case, the processor 104 may execute step S220 to write the first data into the memory medium M.

On the other hand, in response to the processor 104 determining in step S218 that the space size of the first write space of the first data is not less than or equal to the updated total free space, it means that the total free space in the memory medium M is still insufficient to accommodate the first data. In this case, the processor 104 may execute step S224.

In an embodiment, in response to the processor 104 determining in step S216 that there is no excess data type, the processor 104 may also execute step S224.

In step S224, the processor 104 deletes the data belonging to the first data type until the space size of the first write space of the first data is less than or equal to the total free space of the memory medium M.

That is, if the processor 104 determines that no data type is the excess data type, the processor 104 may begin deleting the data belonging to the first data type (for example, older, less important, and/or unlocked data) to try to increase the total free space of the memory medium M.

In an embodiment, after the processor 104 deletes the data belonging to the first data type until the first write space is less than or equal to the total free space of the memory medium M (that is, the total free space of the memory medium M is sufficient to accommodate the first data), the processor 104 may execute step S220 to write the first data into the memory medium M.

As can be seen from the above, the method provided by the embodiment of the disclosure may gradually delete the excess usage portion of the excess data type when the first write space corresponding to the first data is not less than or equal to the total free space of the memory medium M until the total free space of the memory medium M is sufficient to accommodate the first data. If all the data types are not the excess data type (that is, there is no excess usage portion originally or there is no excess usage portion after deletion), the method of the embodiment of the disclosure may gradually delete a part of the data belonging to the first data type until the total free space of the memory medium M is sufficient to accommodate the first data.

In another embodiment, it is assumed that the processor 104 decreases the space size of the pre-allocated memory space (hereinafter referred to as a reference memory space) of a certain data type (hereinafter referred to as a reference data type) among the data types in response to a setting/requirement of the user.

In an embodiment, in response to determining that the space size occupied by reference data of the reference data type in the memory medium M is greater than the decreased space size of the reference memory space, the processor 104 may still maintain the reference data. In other words, the processor 104 does not need to immediately delete the reference data, nor does the processor 104 need to immediately reduce the occupied space to less than the decreased allocated memory space.

Specifically, when the user decreases the space size of the memory space allocated to the reference data type due to a certain requirement, the reference data type may change from not belonging to the excess data type to belonging to the excess data type. In this case, the approach in the prior art is to delete a part of the reference data of the reference data type, so that the reference data type does not belong to the excess data type. However, the approach in the prior art decreases the total amount of data of the reference data type too early and is likely to delete newer, more important, and/or locked data, thereby causing unexpected data loss.

In contrast, the method of the embodiment of the disclosure maintains the reference data instead of immediately deleting any second data after the reference memory space is decreased for some reason. Afterwards, when new data to be written into the memory medium M appears, the processor 104 may regard the new data as the first data and execute the method shown in FIG. 2 accordingly. In this case, the processor 104 may try to enable the memory medium M to be able to accommodate the new data through deleting older, less important, and/or unlocked data. In this way, the above situation of unexpected data loss can be prevented.

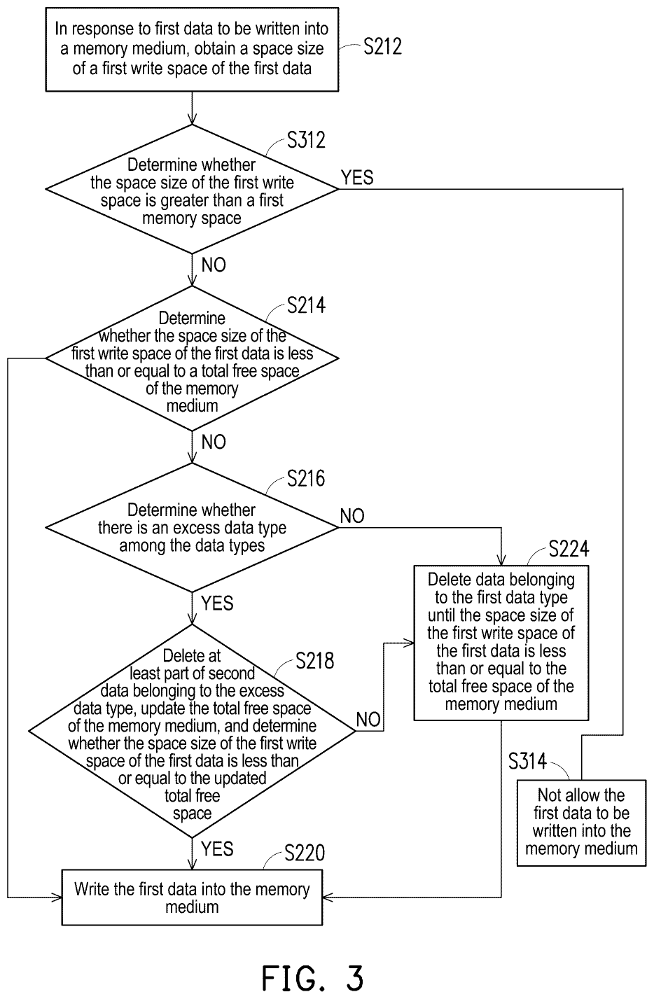

Please refer to FIG. 3, which is a flowchart of another data management method according to FIG. 2. As can be seen from FIG. 3, the main difference from FIG. 2 is that after step S212, the processor 104 further executes step S312 to determine whether the space size of the first write space of the first data is greater than the pre-allocated first memory space of the first data type.

If not, the processor 104 may correspondingly execute step S214; and if yes, the processor 104 may execute step S314 to not allow the first data to be written into the memory medium M (that is, refuse to write the first data into the memory medium M).

For example, it is assumed that the first write space is 50 MB and the first memory space is 40 MB. In this case, the processor 104 may execute step S314 due to determining in step S312 that the space size of the first write space of the first data is greater than the first memory space.

On the other hand, it is assumed that the first write space is 30 MB and the first memory space is 40 MB. In this case, the processor 104 may execute step S214 and subsequent steps due to determining in step S312 that the space size of the first write space of the first data is not greater than the first memory space to try to accommodate the first data through deleting some data of the excess data type. Reference may be made to the related description of FIG. 2 for the description of steps S212 to S224, which will not be elaborated here.

In other words, in the scenario of FIG. 3, only when the space size of the first write space of the first data is not greater than the pre-allocated first memory space of the first data type, the processor 104 allows the first data to be written into the memory medium M.

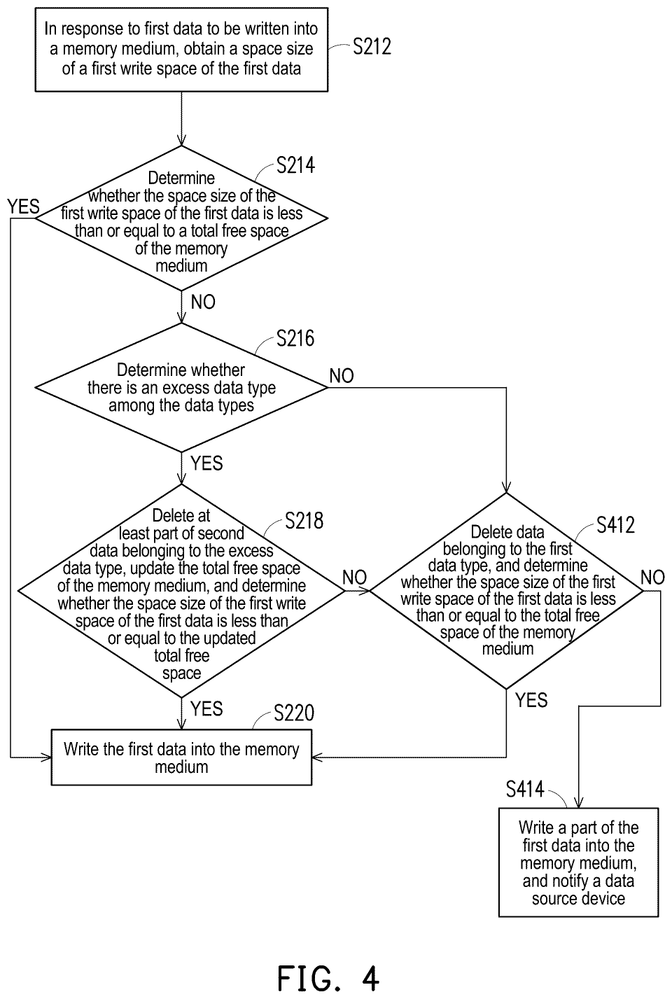

Please refer to FIG. 4, which is a flowchart of yet another data management method according to FIG. 2. As can be seen from FIG. 4, the main difference from FIG. 2 is that after the determination result in step S216 or S218 is no, the processor 104 may continue to execute step S412.

In step S412, the processor 104 may delete the data belonging to the first data type, and determine whether the space size of the first write space of the first data is less than or equal to the total free space of the memory medium M.

If yes, it means that after the processor 104 deletes a part of the data belonging to the first data type, the memory medium M is sufficient to accommodate the first data. Therefore, the processor 104 may correspondingly execute step S220 to write the first data into the memory medium M.

On the other hand, if the determination result by the processor 104 in step S412 is no, it means that after the processor 104 deletes a part of the data belonging to the first data type, the memory medium M is still insufficient to accommodate the first data. In this case, the processor 104 may execute step S414 to write only a part of the first data into the memory medium M, and notify the data source device S. That is, the processor 104 may not write the first data completely into the memory medium M, but only write a part of the first data that may be accommodated by the memory medium M into the memory medium M, and notify the data source device S that only a part of the first write space may be allocated for storage.

In summary, in the technical solutions according to the embodiments of the disclosure, when the total free space of the memory medium is less than or equal to the write space corresponding to the first data, the excess usage portion of the excess data type may be deleted until the total free space of the memory medium is sufficient to accommodate the first data. If all the data types are not the excess data type (that is, there is no excess usage portion), the method of the embodiment of the disclosure may delete a part of the data belonging to the first data type until the total free space of the memory medium is sufficient to accommodate the first data. In this way, the upper limit of the memory space of a single data type can be prevented from being always limited to a specified size. Furthermore, for the data type that does not fully occupy the corresponding memory space, the remaining memory space may be shared with other data types. In addition, the embodiments of the disclosure can also prevent situations such as data that has not been updated for a long time still occupying a large amount of space and unexpected data loss.

Finally, it should be noted that the above embodiments are only used to illustrate, but not to limit, the technical solutions of the disclosure. Although the disclosure has been described in detail with reference to the above embodiments, persons skilled in the art should understand that the technical solutions described in the above embodiments may still be modified or some or all of the technical features thereof may be equivalently replaced. However, the modifications or replacements do not cause the essence of the corresponding technical solutions to deviate from the scope of the technical solutions of the embodiments of the disclosure.

What is claimed is:

1. A data management method, adapted to a data management device, comprising:
in response to a first data type of first data to be written into a memory medium, obtaining a space size of a first write space of the first data, wherein the memory medium is configured with a plurality of memory spaces, the memory spaces respectively correspond to a plurality of data types, the data types comprise the first data type, and the first data type corresponds to a first memory space among the memory spaces;
determining whether the space size of the first write space of the first data is less than or equal to a total free space of the memory medium;
in response to determining that the space size of the first write space of the first data is not less than or equal to the total free space of the memory medium, determining whether there is an excess data type among the data types, wherein a space size occupied by at least one second data belonging to the excess data type in the memory medium is greater than a pre-allocated memory space corresponding to the excess data type among the memory spaces;
in response to determining that there is the excess data type, deleting a part of the at least one second data belonging to the excess data type, updating the total free space of the memory medium, and determining whether the space size of the first write space of the first data is less than or equal to the updated total free space; and
in response to determining that the space size of the first write space of the first data is less than or equal to the updated total free space, writing the first data into the memory medium.

2. The data management method according to claim 1, wherein after the step of determining whether the first write space is less than or equal to the total free space of the memory medium, the data management method further comprises:
in response to the space size of the first write space of the first data being less than or equal to the total free space of the memory medium, writing the first data into the memory medium.

3. The data management method according to claim 1, wherein the part of the at least one second data belonging to the excess data type comprises at least one of oldest data, least important data, and unlocked data in the at least one second data.

4. The data management method according to claim 1, wherein after the step of determining whether the space size of the first write space of the first data is less than or equal to the updated total free space, the data management method further comprises:
in response to determining that the space size of the first write space of the first data is not less than or equal to the updated total free space, deleting data belonging to the first data type until the space size of the first write space of the first data is less than or equal to the total free space of the memory medium; and
writing the first data into the memory medium.

5. The data management method according to claim 1, wherein after the step of determining whether there is the excess data type among the data types, the data management method further comprises:
in response to determining that there is no excess data type, deleting data belonging to the first data type until the space size of the first write space of the first data is less than or equal to the total free space of the memory medium; and
writing the first data into the memory medium.

6. The data management method according to claim 1, wherein after the step of obtaining the space size of the first write space, the data management method further comprises:
in response to determining that the space size of the first write space of the first data is greater than the first memory space, not allowing writing the first data into the memory medium.

7. The data management method according to claim 1, wherein after the step of writing the first data into the memory medium, the data management method further comprises:
in response to determining that a space size of a pre-allocated reference memory space of a reference data type is set to be decreased, maintaining reference data belonging to the reference data type, wherein the reference data type is one of the data types.

8. The data management method according to claim 1, further comprising:
in response to determining that the space size of the first write space of the first data is not less than or equal to the updated total free space or there is no excess data type, deleting data belonging to the first data type, and determining whether the space size of the first write space of the first data is less than or equal to the total free space of the memory medium; and
in response to determining that the space size of the first write space of the first data is not less than or equal to the total free space of the memory medium, writing a part of the first data into the memory medium.

9. A data management device for managing a memory medium, comprising:
a non-transitory memory circuit, storing a program code; and
a processor, coupled to the non-transitory memory circuit and accessing the program code to execute:
in response to a first data type of first data to be written into the memory medium, obtaining a space size of a first write space of the first data, wherein the memory medium is configured with a plurality of memory spaces, the memory spaces respectively correspond to a plurality of data types, the data types comprise the first data type, and the first data type corresponds to a first memory space among the memory spaces;
determining whether the space size of the first write space of the first data is less than or equal to a total free space of the memory medium;
in response to determining that the space size of the first write space of the first data is not less than or equal to the total free space of the memory medium, determining whether there is an excess data type among the data types, wherein a space size occupied by at least one second data belonging to the excess data type in the memory medium is greater than a pre-allocated memory space corresponding to the excess data type among the memory spaces;
in response to determining that there is the excess data type, deleting a part of the at least one second data belonging to the excess data type, updating the total free space of the memory medium, and determining whether the space size of the first write space of the first data is less than or equal to the updated total free space; and
in response to determining that the space size of the first write space of the first data is less than or equal to the updated total free space, writing the first data into the memory medium.
